(19) United States
(12) Patent Application Publication
(10) Pub. No.: US 2017/0093259 A1
(43) Pub. Date: Mar. 30, 2017

(54) Brushless Motor

(71) Applicant: Johnson Electric S.A., Murten (CH)

(72) Inventors: Yue LI, Hong Kong (CN); Chui You ZHOU, Shenzhen (CN); Yong WANG, Shenzhen (CN); Yong LI, Shenzhen (CN)

(21) Appl. No.: 15/281,894

(22) Filed: Sep. 30, 2016

(30) Foreign Application Priority Data
Sep. 30, 2015 (CN) 201510641847.2
Jul. 29, 2016 (CN) 201610616155.7

(51) Int. Cl. H02K 21/16; H02K 3/28; H02K 3/18; H02K 1/14; H02K 1/27

(52) U.S. Cl. CPC H02K 21/16; H02K 1/146; H02K 1/2706; H02K 3/18; H02K 3/28

(57) ABSTRACT

A brushless motor includes a stator and a rotor. The stator includes a stator core and a plurality of windings. The stator core includes a yoke, and a plurality of teeth extending from the yoke. Each of the teeth comprising two pole shoes extending in opposite ways along a circumferential direction of the yoke. Pole shoes of adjacent teeth are connected through a magnetic bridge having a larger magnetic reluctance than that of the poles shoes, which reduces the magnetic leakage and increases the motor power density. Axial thickness of each of the magnetic bridges is smaller than that of the poles shoes.

### CROSS REFERENCE TO RELATED APPLICATIONS

This non-provisional patent application claims priority under 35 U.S.C. §119(a) from Patent Application No. 201510641847.2 filed in The People's Republic of China on Sep. 30, 2015, and Patent Application No. 201610616155.7 filed in The People's Republic of China on Jul. 29, 2016.

### FIELD OF THE INVENTION

The present invention relates to the field of motors, and in particular to a brushless motor.

### BACKGROUND OF THE INVENTION

Brushless motors are widely used due to the advantages of compact size, high reliability, long lifespan and low noise. A stator of the brushless motor includes a stator core having a plurality of stator teeth each forming a stator pole, and windings respectively wound around the stator teeth. In general, for a motor having a determined size, the larger the number of the stator teeth, the shorter the magnetic path between adjacent stator teeth, the less the iron loss during operation of the motor, and the higher the energy conversion efficiency. However, the larger number of the stator teeth leads to increased winding material consumption and more space to be occupied and is often restricted in some applications.

### SUMMARY OF THE INVENTION

Thus, there is a desire for a brushless motor with reduced size and enhanced energy conversion efficiency.

A brushless motor includes a stator and a rotor. The stator includes a stator core and a plurality of windings. The stator core includes a yoke, and a plurality of teeth extending from the yoke. Each of the teeth comprising two pole shoes extending in opposite ways along a circumferential direction of the yoke. Pole shoes of adjacent teeth are connected through a magnetic bridge having a larger magnetic reluctance than that of the poles shoes, which reduces the magnetic leakage and increases the motor power density. Axial thickness of each of the magnetic bridges is smaller than that of the poles shoes.

### BRIEF DESCRIPTION OF THE DRAWINGS

FIG. 1 illustrates a brushless motor according to one embodiment of the present invention.

FIG. 2 is an exploded view of a stator core, a first support bracket and a second support bracket of the brushless motor of FIG. 1.

FIG. 3 is a plane view of the stator core and a rotor of the brushless motor of FIG. 1.

FIG. 4 is an exploded view of an mounting bracket of the brushless motor of FIG. 1.

FIG. 5 is an exploded view of the rotor used in the brushless motor of FIG. 1

FIG. 6 is an exploded view of another rotor applicable in the brushless motor of FIG. 1.

FIG. 7 is a plane view of a stator core and a rotor of a brushless motor according to a second embodiment of the present invention.

FIG. 8 is an exploded view of a first implementation of the rotor applicable in the brushless motor of FIG. 7.

FIG. 9 is an exploded view of a second implementation of the rotor applicable in the brushless motor of FIG. 7.

FIG. 10 is a plane view of a stator core and a rotor of a brushless motor according to a third embodiment of the present invention.

FIG. 11 is a plane view of a stator core and a rotor of a brushless motor according to a fourth embodiment of the present invention.

FIG. 12 is a plane view of a stator core and a rotor of a brushless motor according to a fifth embodiment of the present invention.

FIG. 13 is a perspective view of a stator core of FIG. 12.

FIG. 14 is a plane view of a stator core and a rotor of the brushless motor according to a sixth embodiment of the present invention.

FIG. 15 is a perspective view of the stator core of FIG. 14.

FIG. 16 is a plane view of a stator core and a rotor of the brushless motor according to a seventh embodiment of the present invention.

FIG. 17 is a plane view of a stator core and a rotor of the brushless motor according to an eighth embodiment of the present invention.

FIG. 18 is a plane view of a stator core and a rotor of the brushless motor according to a ninth embodiment of the present invention.

FIG. 19 is a perspective view of the stator core of FIG. 18.

FIG. 20 is a plane view of a stator core and a rotor of the brushless motor according to a tenth embodiment of the present invention.

FIG. 21 is a perspective view of the stator core of FIG. 20.

FIG. 22 is a perspective view of another stacking manner of the stator core of FIG. 20.

FIG. 23 is a plane view of a stator core and a rotor of the brushless motor according to an eleventh embodiment of the present invention.

FIG. 24 is a perspective view of the stator core of FIG. 23.

FIG. 25 is a plane view of a stator core and a rotor of the brushless motor according to a twelfth embodiment of the present invention.

FIG. 26 is a perspective view of the stator core of FIG. 25.

FIG. 27 is a perspective view of another stacking manner of the stator core of FIG. 20.

### DETAILED DESCRIPTION OF THE PREFERRED EMBODIMENTS

Embodiments of the present invention are described in detail below with reference to the accompanying drawings.

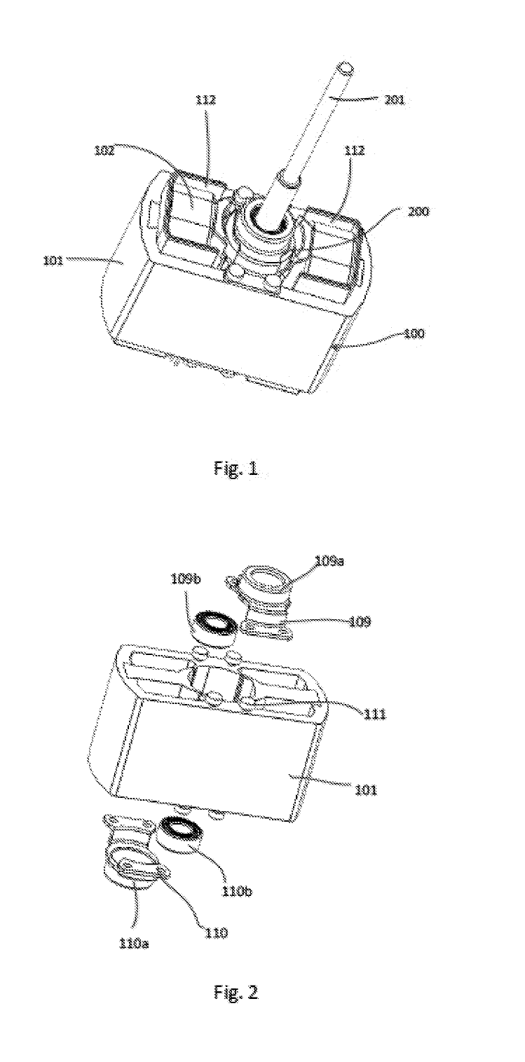

Referring to FIG. 1 and FIG. 2, the brushless motor 500 of the present invention includes a stator 100 and a rotor 200 rotatable relative to the stator 100.

The stator 100 includes a stator core 101, some mounting brackets 112 mounted to the stator core 101, some windings 102 respectively wound around the mounting bracket 112, a first support bracket 109 and a second support bracket 110 mounted to the stator core 101. The stator core 101 is made from a magnetic-conductive material. The first support bracket 109 and the second support bracket 110 are mounted to two axial sides of the stator core 101, respectively, for supporting a rotary shaft 201 of the rotor 200. Specifically, the stator core 101 has through holes enable fasteners 111 to pass therethrough. The first support bracket 109 and the second support bracket 110 are connected by the axial fasteners 111, so as to sandwich and fix the stator core 101 between the first and second support brackets. Preferably, each of the first support bracket 109 and the second support bracket 110 is an integrally formed member. The first support bracket 109 and the second support bracket 110 include annular hubs 109a, 110a for mounting bearings 109b, 110b, respectively. The bearings 109b, 110b are used to support the rotary shaft 201 of the rotor 200 such that the rotary shaft 201 is capable of rotation relative to the stator 100.

### First Embodiment

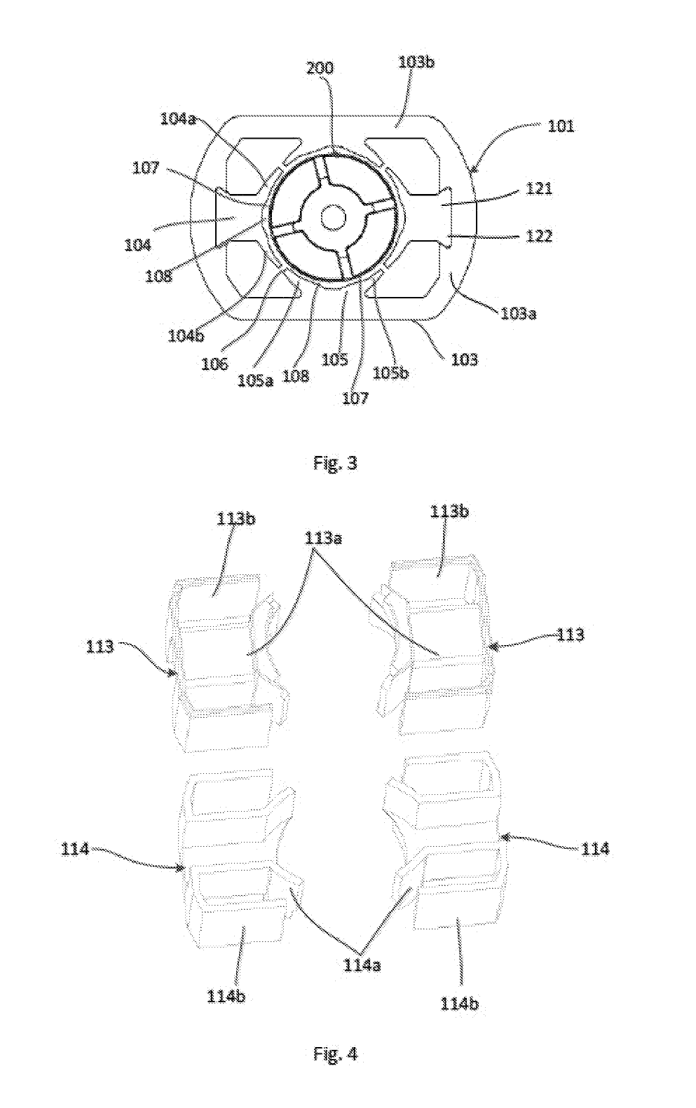

Referring to FIG. 3, the brushless motor of this embodiment is a single phase brushless motor. The stator core 101 includes a yoke 103, two opposing first teeth 104, and two opposing second teeth 105. The yoke 103 includes two arcuate sidewalls 103a, from which the two first teeth 104 respectively depend, and two flat sidewalls 103b, from which the two second teeth 105 respectively depend. The arcuate sidewalls 103a and the flat sidewalls 103b are alternatively connected end-to-end to form a ring shaped structure. The two arcuate sidewalls 103a and the two flat sidewalls 103b are integrally formed to facilitate fabrication thereof. Of course, the two arcuate sidewalls 103a and the two flat sidewalls 103b may also be separately formed.

In this embodiment, the first teeth 104 and the arcuate sidewall 103a are separately formed. each of the first teeth 104 is connected to the corresponding one arcuate sidewall 103a with a recess-protrusion engagement structure. The recess-protrusion engagement structure includes a dovetail tenon 121 formed at an end of the first tooth 104 and a dovetail mortise 122 defined in the arcuate sidewall 103a. The dovetail tenon 121 is engaged in the dovetail mortise 122 so as to lockingly connect the first tooth 104 and the arcuate sidewall 103a. It should be understood that the first teeth 104 may also be integrally formed with the arcuate sidewalls 103a, respectively. The second teeth 105 and the flat sidewalls 103b are integrally formed, respectively. Alternatively, the first teeth 104 and the arcuate sidewall 103a are separately formed, and the second teeth 105 and the flat sidewall 103b are also separately formed.

Referring to FIG. 4, each mounting bracket 112 includes an upper bracket portion 113 and a lower bracket portion 114. The upper bracket portion 113 and the lower bracket 114 portion are respectively mounted to two opposite axial ends of one of the first tooth 104 to respectively cover two axial end surfaces of the first tooth 104. The upper bracket portion 113 include an upper bobbing 113a and two L-shaped guard plates 113b extending from an outer radial end of the upper bobbing 113a along opposite sides of the upper bobbing 113a. The lower bracket portion 114 include an lower bobbing 114a and two L-shaped guard plates 114b extending from an outer radial end of the lower bobbing 114a along opposite sides of the lower bobbing 114a. The windings 102 are respectively wound around the upper and lower bobbin portions 113a and 114a, and are insultingly separated apart from the stator core 101 by the mounting bracket 112.

The windings 102 are wound only on the two first teeth 104 to form two main stator poles with same the same polarity. The two second teeth 105 are not wound with the windings 102 and then form two auxiliary poles with the polarity opposite to that of the main poles. Since the two first teeth 104 and the two second teeth 105 are alternatively arranged along a circumferential direction of the yoke 103, the main poles and the auxiliary poles are alternatively arranged. Accordingly, the motor 500 of this embodiment forms four stator poles with only two windings 120, which can reduce cost while enhancing the efficiency of the motor 500. In addition, because the second teeth 105 are not wound with the windings, the second teeth 105 can have a small length, thus saving space.

Each first tooth 104 includes two main pole shoes 104a, 104b extending in opposite ways along a circumferential direction, and each second tooth 105 includes two auxiliary pole shoes 105a, 105b extending in opposite ways along a circumferential direction. A radial thickness of the main pole shoes 104a, 104b progressively decreases along an extending way thereof. A radial thickness of the auxiliary pole shoes 105a, 105b progressively decreases along an extending way thereof. Distal ends of adjacent main pole shoe and auxiliary pole shoe are separated from each other to define a slot opening 106 therebetween. The slot opening 106 can reduce magnetic leakage and increase the power density of the motor 500, thereby enhancing the operating efficiency of the motor 50.

Because the motor is a single phase brushless motor, each of the first teeth 104 and the second teeth 105 defines a positioning groove 108 facing the rotor 200. The positioning groove 108 of each first tooth 104 is located between the two main pole shoes 104a, 104b, preferably located on a circumferential center line of the first tooth 104. The positioning groove 108 of each second tooth 105 is located between the two auxiliary pole shoes 105a, 105b, preferably located on a circumferential center line of the second tooth 105. Each of the positioning grooves 108 have an arc-shaped cross-section. The provision of the positioning grooves 108 can effectively prevent the motor 500 from stopping at the dead point position, thus increasing the startup capability of the motor 50. Furthermore, when the positioning grooves 108 are disposed at circumferential center lines of the first teeth 104 and the second teeth 105, the motor 500 is provided with bidirectional startup capability.

The rotor 200 is received in a space cooperatively defined by the main pole shoes 104a, 104b of the two first teeth 104 and the auxiliary pole shoes 105a, 105b of the two second teeth 105. An outer circumferential surface of the rotor 200 is located on a same circle. Air gaps 107 are formed between an outer circumferential surface of the rotor 200, and respective pole faces of the first teeth 104 and the second teeth 105, for allowing the rotor 200 to rotate relative to the stator 100. The poles faces are end surfaces of the main pole shoes 104a, 104b of each first tooth 104 and the auxiliary pole shoes 105a, 105b of each second tooth 105 facing the rotor 200.

In this embodiment, each of the air gaps 107 has an uneven thickness, and is asymmetric with regarded to a central line of the corresponding one of the first teeth 104 and the second teeth 105, such that the motor 500 has different startup capability in opposite startup directions. In particular, circumferential lengths of the main pole shoes 104a and 104b of each first tooth 104 are equal to each other. The pole face of the main pole shoe 104a is concentric with the outer circumferential surface of the rotor 200. The pole face of the main pole shoe 104b is concentric with the outer circumferential surface of the rotor 200, i.e. a center of circle associated with the pole face of the main pole shoe 104b is offset from a center of rotation of the rotor 200. In addition, the radial thickness of the main pole shoe 104a is greater than the radial thickness of the main pole shoe 104b. Circumferential lengths of the auxiliary pole shoes 105a and 105b of each second tooth 105 are equal to each other. The pole face of the auxiliary pole shoes 105a is concentric with the outer circumferential surface of the rotor 200. The pole face of the auxiliary pole shoes 105b is eccentric with the outer circumferential surface of the rotor 200, i.e. a center of circle associated with the pole face of the auxiliary pole shoes 105b is offset from a center of rotation of the rotor 200. In addition, the radial thickness of the auxiliary pole shoes 105a is greater than the radial thickness of the auxiliary pole shoes 105b. The provision of the asymmetric air gap 107 with uneven thickness can change the cogging torque curve thus optimizing the performance of the motor 500.

In an alternative implementation, circumferential lengths of the main pole shoes 104a and 104b of each first tooth 104 are equal to each other. The pole faces of the main pole shoes 104a and 104b of each first tooth 104 are located on a same circumferential surface, but eccentric with the outer circumferential surface of the rotor 200, i.e. a center of circle associated with the pole faces of the main pole shoes 104a and 104b is offset from the center of rotation of the rotor 200. Circumferential lengths of the auxiliary pole shoes 105a and 105b of each second tooth 105 are equal to each other. The pole faces of the auxiliary pole shoes 105a and 105b of each second tooth 105 are located on a same circumferential surface, but eccentric with the outer circumferential surface of the rotor 200, i.e. a center of circle associated with the pole faces of the auxiliary pole shoes 105a and 105b is offset from the center of rotation of the rotor 200. As such, the air gap 107 has an uneven thickness, and is asymmetric with regarded to a central line of the corresponding one of the first teeth 104 and the second teeth 105.

In another alternative implementation, circumferential lengths of the main pole shoes 104a and 104b of each first tooth 104 are unequal to each other. The pole faces of the main pole shoes 104a and 104b of each first tooth 104 are located on a same circumferential surface, but eccentric with the outer circumferential surface of the rotor 200, i.e. a center of circle associated with the pole faces of the main pole shoes 104a, 104b is offset from the center of rotation of the rotor 200. Circumferential lengths of the auxiliary pole shoes 105a and 105b of each second tooth 105 are unequal to each other. The pole faces of the auxiliary pole shoes 105a and 105b of each second tooth 105 are located on a same circumferential surface, but eccentric with the outer circumferential surface of the rotor 200, i.e. a center of circle associated with the pole faces of the auxiliary pole shoes 105a and 105b is offset from the center of rotation of the rotor 200. As such, the air gap 107 has an uneven thickness, and is asymmetric with regarded to a central line of the corresponding one of the first teeth 104 and the second teeth 105.

The slot opening 106 has a width not greater than four times of a minimal radial thickness of the air gaps 107, which results in stable and reliable operation of the motor 500 and strong startup capability. Preferably, the width of the slot opening 106 is greater than the minimal radial thickness of the air gaps 107, and not greater than three times of the minimal radial thickness of the air gaps 107.

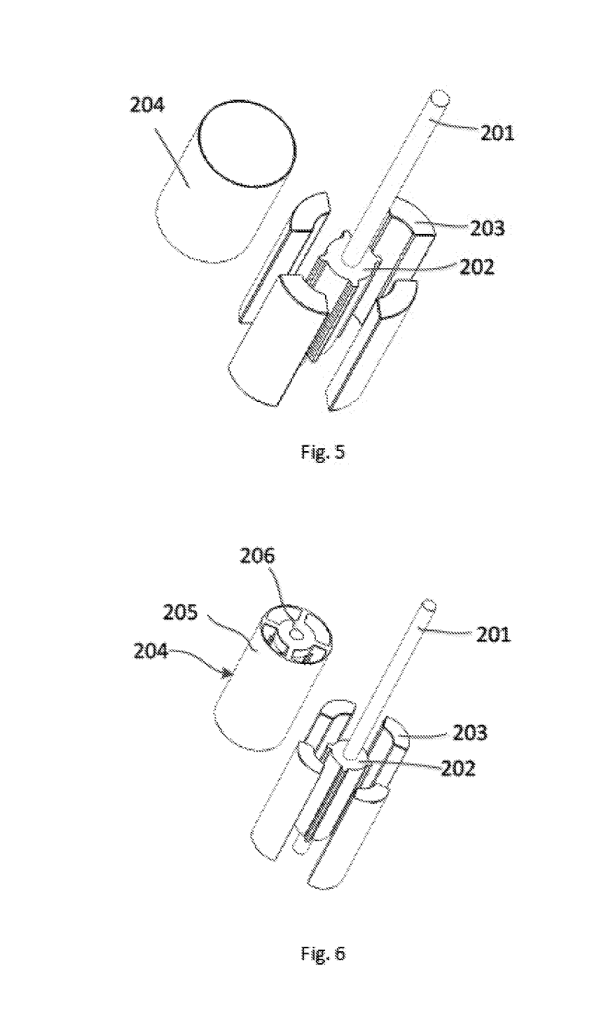

Referring to FIG. 5, in this embodiment, the rotor 200 includes a rotary shaft 201, a rotor core 202 fixed to the rotary shaft 201, a plurality of permanent magnets 203 attached to an outer circumferential surface of the rotor core 202, and a holding member 204. The holding member 204 is attached around the rotor core 202 and tightly hoops the permanent magnets 203, thus holding the permanent magnets 203 from loosening. In this embodiment, the number of the permanent magnets 203 is four. Preferably, the permanent magnets 203 are arcuate with the same curvature with rotor core 202, and equal in radial thickness.

FIG. 6 shows an alternative rotor 200 structure. Different from the above first embodiment, the holding member 204 includes a barrel-shaped main portion 205 and two connecting portions 206 respectively connected to opposite axial ends of the main portion 205. The main portion 205 tightly hoops the permanent magnets 203, and the two connecting portions 206 are connected to the rotary shaft 201. Preferably, the holding member 204 is an integrally formed member overmolded on the permanent magnets 203, the rotor core 202 and the shaft 201.

### Second Embodiment

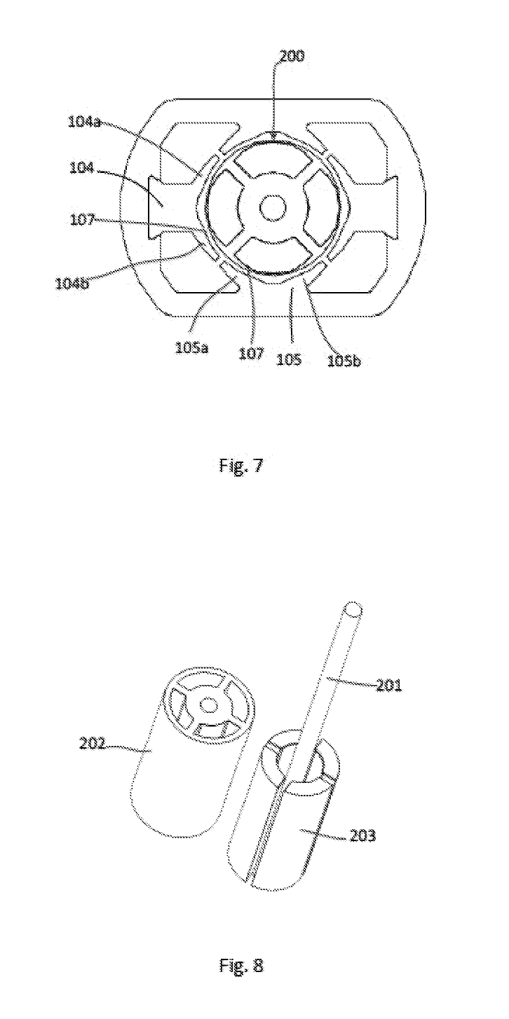

Referring to FIG. 7, this embodiment differs from the first embodiment mainly in that, each of the air gaps 107 has an even thickness, and is symmetrical with regarded to a central line of the corresponding one of the first teeth 104 and the second teeth 105. Therefore, the cogging torque and startup angle can be routinely designed, and the motor 500 is provided with the same startup capability in both directions.

In particular, circumferential lengths of the main pole shoes 104a and 104b of each first tooth 104 are equal to each other. The pole faces of the main pole shoes 104a and 104b of each first tooth 104 are located on a same circumferential surface concentric with the outer circumferential surface of the rotor 200, i.e. a center of circle associated with the pole faces of the main pole shoes 104a and 104b coincides with the center of rotation of the rotor 200. Circumferential lengths of the auxiliary pole shoes 105a and 105b of each second tooth 105 are equal to each other. The pole faces of the auxiliary pole shoes 105a and 105b of each second tooth 105 are located on a same circumferential surface concentric with the outer circumferential surface of the rotor 200, i.e. a center of circle associated with the pole faces of the auxiliary pole shoe 105a and 105b coincides with the center of rotation of the rotor 200.

In this embodiment, the poles faces of the main poles shoes 104a, 104b and the auxiliary pole shoes 105a, 105b are all are located on the same circle concentric with the outer circumferential surface of the rotor 200, therefore, all of the air gaps 127 are uneven and equal in thickness.

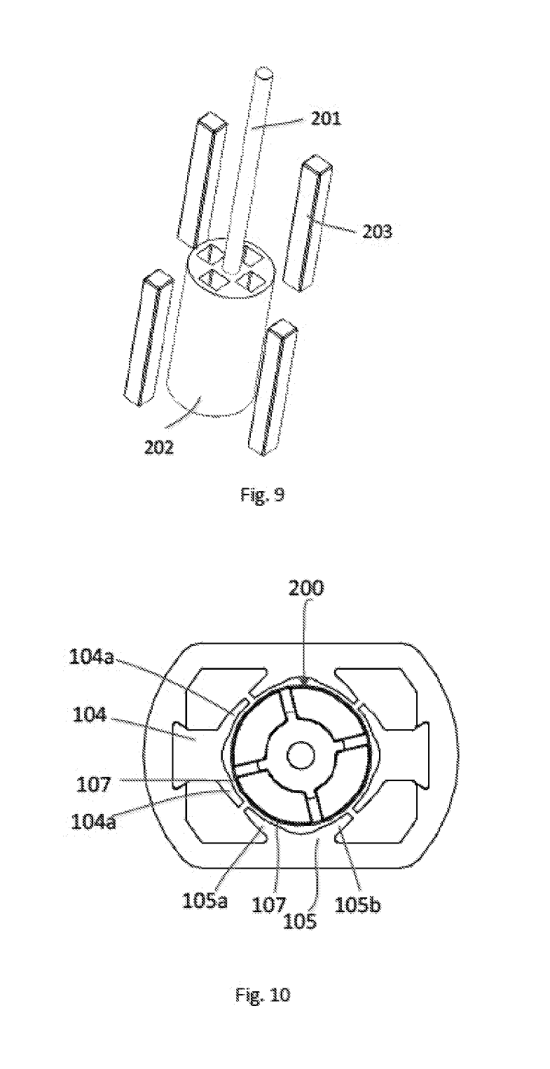

Referring to FIGS. 8 and 9, in this embodiment, the rotor 200 includes a rotary shaft 201, a rotor core 202 fixed to the rotary shaft 201, and a plurality of permanent magnets 203 embedded in the rotor core 202. In this embodiment, the number of the permanent magnets 203 is four. As shown in FIG. 8, each permanent magnet 203 is arcuate with an uneven axial thickness, which progressively decreases from a circumferential center to two circumferential ends thereof. It should be understood that the thickness of the permanent magnet may also has an even axial thickness. It should be understood that, as shown in FIG. 9, the permanent magnet 203 may also be a square permanent magnet with an even thickness.

FIG. 9 shows an alternative rotor 200 structure. The rotor 200 differs from the rotor 200 of FIG. 8 mainly in that the permanent magnet 203 is a square with an even thickness.

### Thirst Embodiment

Referring to FIG. 10, this embodiment differs from the second embodiment mainly in that, this embodiment differs from the first embodiment mainly in that, each of the air gaps 107 has an even thickness, and is asymmetric with regarded to a central line of the corresponding one of the first teeth 104 and the second teeth 105.

In particular, circumferential length of the main pole shoe 104a of each first tooth 104 is greater than that of the main pole shoe 104b of the first tooth 104b. The pole faces of the main pole shoes 104a and 104b of each first tooth 104 are located on a same circumferential surface concentric with the outer circumferential surface of the rotor 200, i.e. a center of circle associated with the pole faces of the main pole shoes 104a and 104b coincides with the center of rotation of the rotor 200. Circumferential length of the auxiliary pole shoe 105a of each second tooth 105 is greater than that of the auxiliary pole shoe105b of the second tooth 105b. The pole faces of the auxiliary pole shoes 105a and 105b of each second tooth 105 are located on a same circumferential surface concentric with the outer circumferential surface of the rotor 200, i.e. a center of circle associated with the pole faces of the auxiliary pole shoes 105a and 105b coincides with the center of rotation of the rotor 200.

The pole faces of the main pole shoes 104a and 104b of each first tooth 104 are located on a same circumferential surface concentric with the outer circumferential surface of the rotor 200, i.e. a center of circle associated with the pole faces of the main pole shoes 104a and 104b coincides with the center of rotation of the rotor 200. Circumferential lengths of the auxiliary pole shoes 105a and 105b of each second tooth 105 are equal to each other. The pole faces of the auxiliary pole shoes 105a and 105b of each second tooth 105 are located on a same circumferential surface concentric with the outer circumferential surface of the rotor 200, i.e. a center of circle associated with the pole faces of the auxiliary pole shoe 105a and 105b coincides with the center of rotation of the rotor 200. With the air gap 107 having even thickness and being asymmetric, cogging torque of the motor 500 can be optimized and the motor 500 is provided with unidirectional startup capability.

The structure of the rotor 200 is similar to the structure of the rotor 200 of FIG. 8 and, therefore, is not repeated herein. It should be understood that the motor 500 can also use the rotor 200 illustrated in FIG. 5 and FIG. 6.

### Fourth Embodiment

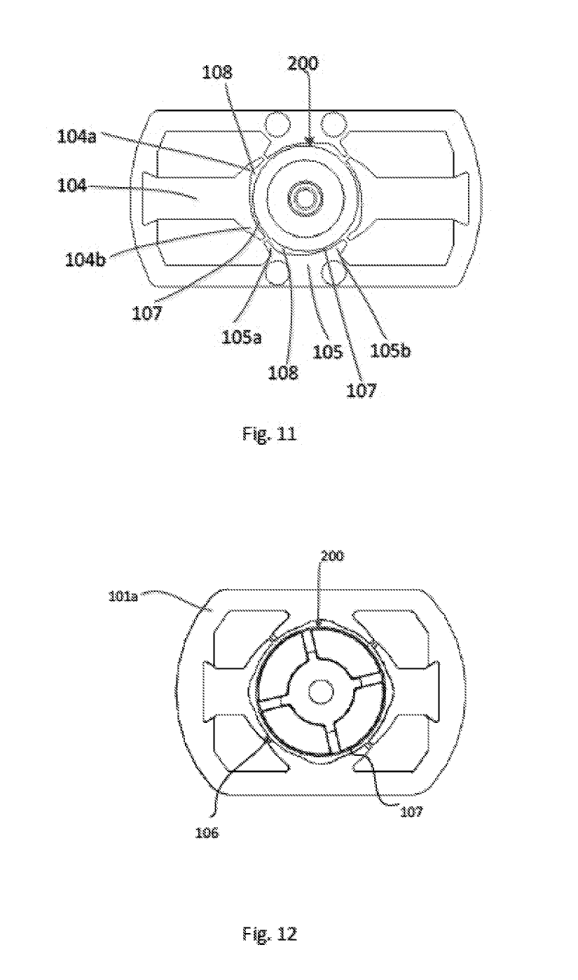

Referring to FIG. 11, different from the second embodiment, the positioning grooves 108 are offset from circumferential centers of the corresponding first teeth 104 and the second teeth 105, such that asymmetric air gaps 107 with even thickness are formed, which provides the motor 50 with unidirectional startup capability.

### Fifth Embodiment

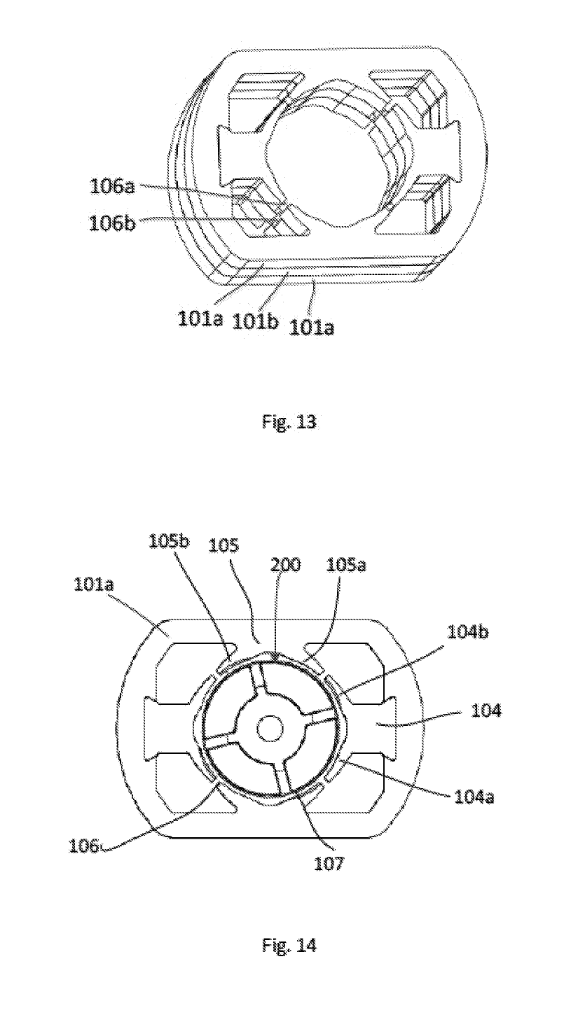

Referring to FIG. 12 and FIG. 13, different from the third embodiment, the stator core 101 includes first stator core laminations 101a and second stator core laminations 101b stacked axially. Not all pole shoes of the first stator core laminations 101a and the second stator core laminations 101b have the same circumferential length. Therefore, the first stator core laminations 101a and the second stator core laminations 101b are staggeringly arranged at the slot openings 106 in the circumferential direction. For example, the pole shoe 106a of the first stator core lamination 101a is stacked on the pole shoe 106b of the second stator core lamination 101b, but has a smaller circumferential length than that of the pole shoe 106b.

Preferably, circumferential lengths of two pole shoes of each tooth (e.g. the main pole shoes 104a, 104b of the first teeth 104, or the auxiliary pole shoes 105a and 105b of the second teeth 105) of the first stator core lamination 101a are unequal. Circumferential lengths of the two pole shoes of each of the teeth (e.g. the first teeth 104, the second teeth 105) of the second stator core lamination 101b are also unequal. More preferably, the first stator core lamination 101a is converted into the second stator core lamination 101b after rotating it 180 degrees, i.e. the first stator core lamination 101a and the second stator core lamination 101b have an identical structure for facilitating fabrication thereof. In stacking, the circumferential center of each first tooth 104 and the circumferential center of each second tooth 105 of the first stator core 101a are aligned with the circumferential center of each first tooth 104 and the circumferential center of each second tooth 105 of the second stator core 101b in an axial direction of the motor 500, thus resulting in the slot openings 106 being staggeringly arranged to reduce the cogging torque of the motor 500 while avoiding the magnetic leakage. Because the two pole shoes of each tooth of the first stator core lamination 101a and/or the second stator core lamination 101a have unequal lengths, it will be appreciated asymmetric air gaps 107 are formed. In addition, to meet different requirements in various applications, the air gaps 107 may be even in thickness or, alternatively, may be uneven in various manners as described in the first embodiment.

In this embodiment, one layer of first stator core lamination 101a and one layer of second stator core lamination 101b are alternatively stacked in the stator core 101. It should be understood that alternatively stacking a plurality of first stator core laminations 101a with a plurality of second stator core laminations 101b is also possible.

### Sixth Embodiment

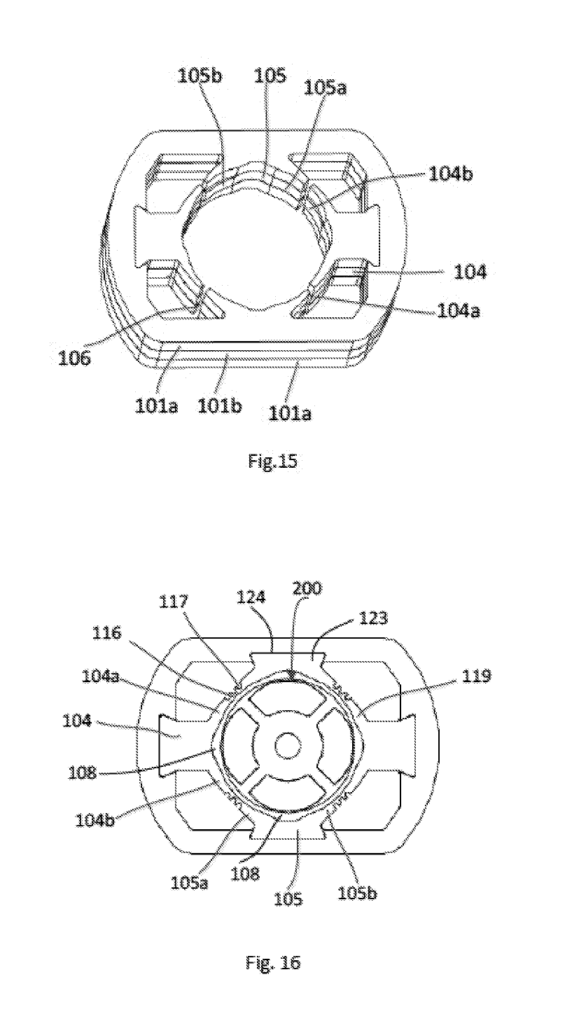

Referring to FIG. 14 and FIG. 15, the stator core 101 of this embodiment includes the axially stacked first stator core laminations 101a and second stator core laminations 101b.

The pole faces of the stator core 101 are staggered in the radial direction. For example, in the first stator core lamination 101a, the main pole shoe 104a of the first tooth extends closer to the rotor 200 than the main pole shoe 104b, the auxiliary pole shoe 105a of the second tooth extends closer to the rotor 200 than the auxiliary shoe 105b. However, in the second stator core lamination 101b, the main pole shoe 104b of the first tooth extends closer to the rotor 200 than the main pole shoe 104a, the auxiliary pole shoe 105b of the second tooth extends closer to the rotor 200 than the auxiliary shoe 105a.

Preferably, the first stator core lamination 101a is converted into the second stator core lamination 101b after rotating it 180 degrees, i.e. the first stator core lamination 101a and the second stator core lamination 101b have an identical structure for facilitating fabrication thereof. In stacking, the circumferential center of each first tooth 104 and the circumferential center of each second tooth 105 of the first stator core 101a are aligned with the circumferential center of each first tooth 104 and the circumferential center of each second tooth 105 of the second stator core 101b in an axial direction of the motor 500, thus resulting in the pole faces with the staggering arrangement. Because the two pole shoes of each tooth of the first stator core lamination 101a and/or of the second stator core lamination 101a are spaced from the rotor 200 by different distances, it will be appreciated that asymmetric and uneven air gaps 107 are formed.

In this embodiment, one layer of first stator core lamination 101a and one layer of second stator core lamination 101b are alternatively stacked in the stator core 101. It should be understood that alternatively stacking a plurality of first stator core laminations 101a with a plurality of second stator core laminations 101b is also possible.

### Seventh Embodiment

Referring to FIG. 16, different from the first embodiment, the second teeth 105 and the flat sidewall 103b are also separately formed in this embodiment. each of the second teeth 105 is connected to the corresponding one flat sidewall 103b with a recess-protrusion engagement structure. The recess-protrusion engagement structure includes a dovetail tenon 121 formed at an end of the first tooth 104 and a dovetail mortise 122 defined in the arcuate sidewall 103a. The dovetail tenon 123 is engaged in the dovetail mortise 124 so as to lockingly connect the second tooth 105 and the flat sidewall 103b.

Each of the main pole shoes 104a, 104b is connected to the adjacent auxiliary pole shoes 105a, 105b through a magnetic bridge 116 having a larger magnetic reluctance than the main pole shoes 104a, 104b and the auxiliary pole shoes 105a, 105b. In comparison with the design with the slot openings 106, the magnetic bridges 116 between the main pole shoes 10a, 104b and the auxiliary pole shoes 105a, 105b can reduce vibrations and noises in operation of the motor 500. In addition, the relative positions between the first teeth 104 and the second teeth 105 are retained, thus facilitates the assembly of the windings 102.

Axially-extending grooves 117 are defined in a radial outer side surface of each of the magnetic bridge 116. The number of the axial axially-extending grooves 117 in each of the magnetic bridge 116 is an odd number. In this embodiment, the number of the axially-extending grooves 117 is three. The axially-extending tree grooves are spacedly arranged in a circumferential direction of the magnetic bridge 116. A cross-section of each of the grooves 117 is U-shaped. The provision of the groove 117 facilitates increasing the magnetic reluctance of the magnetic bridge 116.

The rotor 200 is received in a space defined by the inner ring portion 119. The outer circumferential surface of the rotor 200 is located on a same circle. In one embodiment, the two main pole shoes 104a, 104b of each first tooth 104 are symmetrical with each other, the pole faces of the two main pole shoes and the outer circumferential surface of the rotor 200 are concentric with each other, the two auxiliary pole shoes 105a, 105b of each second tooth 105 are symmetrical with each other, and the pole faces of the two auxiliary pole shoes and the outer circumferential surface of the rotor 200 are concentric with each other, such that symmetrical air gaps 107 are formed between the two main pole shoes 104a, 104b of each first tooth 104 and the rotor 200, and between the two auxiliary pole shoes 105a, 105b of each second tooth 105 and the rotor 200, respectively.

In an alternative embodiment, the two main pole shoes 104a, 104b of each first tooth 104 are symmetrical with each other, and the pole faces of the two main pole shoes 104a, 104b and the outer circumferential surface of the rotor 200 are eccentric with each other, i.e. a center of circle associated with the pole faces of the two main pole shoes 104a, 104b is offset from the center of rotation of the rotor 200; the two auxiliary pole shoes 105a, 105b of each second tooth 105 are symmetrical with each other, and the pole faces of the two auxiliary pole shoes 105a, 105b and the outer circumferential surface of the rotor 200 are eccentric with each other, i.e. a center of circle associated with the pole faces of the two auxiliary pole shoes 105a, 105b is offset from the center of rotation of the rotor 200. As such, asymmetric air gaps 107 with uneven thickness are formed between the two main pole shoes 104a, 104b of each first tooth 104 and the rotor 200, and between the two auxiliary pole shoes 105a, 105b of each second tooth 105 and the rotor 200, respectively.

Referring to FIGS. 5, 6, 8, and 9, the rotor 200 may be any of the structures as described above.

### Eighth Embodiment

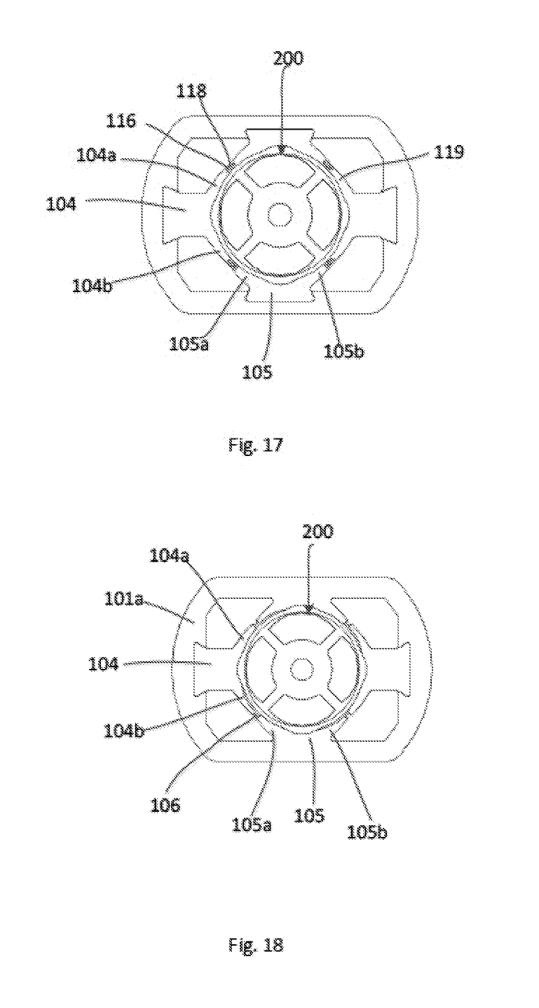

Referring to FIG. 17, different from the seventh embodiment, axially-extending through holes 118, instead of axially-extending grooves 117, are defined in the magnetic bridge 116. The provision of the through hole 118 likewise can increase the magnetic reluctance. The number of the through holes 118 in each of the magnetic bridge 116 is an odd number. In this embodiment, the number of the through holes 118 is three. The through holes 118 are spacedly arranged along a circumferential direction of the magnetic bridge 116. A middle one of the through holes 118, which is communicated to the cutouts 106, is greater than side ones in diameter. Such that the middle area of the magnetic bridge 116 has the maximal magnetic reluctance.

### Ninth Embodiment

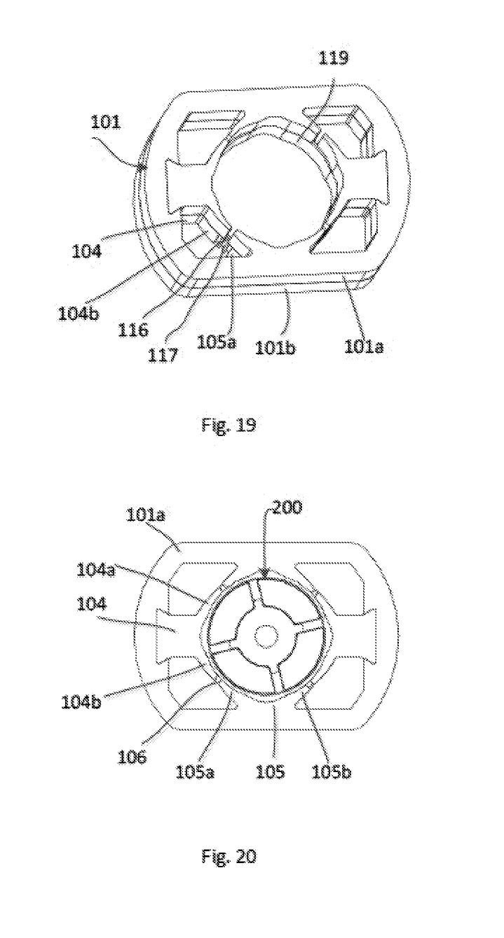

Referring to FIG. 18 and FIG. 19, each of the main pole shoes 104a, 104b is connected to the adjacent auxiliary pole shoes 105a, 105b through a magnetic bridge 116 having a larger magnetic reluctance than the main pole shoes 104a, 104b and the auxiliary pole shoes 105a, 105b. However, the stator core 101 defines one or more cutouts 106 adjacent to each magnetic bridge 116. At least one opposite axial ends of each cutout 106 is closed by the corresponding one magnetic bridge 116. Therefore, an axial thickness of the magnetic bridge 116 of the rotor is less than that of other parts of the stator core 101, e.g. the main pole shoes 104a, 104b and the auxiliary pole shoes 105a, 105b.

In particular, the stator core 101 includes first stator core laminations 101a and second stator core laminations 101b axially stacked. The circumferential center of each first tooth 104 and the circumferential center of each second tooth 105 of the first stator core 101a are receptively aligned with the circumferential center of each first tooth 104 and the circumferential center of each second tooth 105 of the second stator core 101b in an axial direction of the motor 500. The cutouts 106 are defined in the first stator core lamination 101a, and respectively between the two main pole shoes 104a, 104b of each first tooth 104 in the first stator core lamination 101a and the auxiliary pole shoes 105b, 105a of the adjacent second teeth 105 in the first stator core lamination 101a. The two main pole shoes 104a, 104b of each first tooth 104 in the second stator core lamination 101b are respectively connected with the auxiliary pole shoes 105b, 105a of the adjacent second teeth 105.

In this embodiment, circumferential lengths of the main pole shoes 104a and 104b of each first tooth 104 are equal to each other. The pole face of the main pole shoe 104a is concentric with the outer circumferential surface of the rotor 200. The pole face of the main pole shoe 104b is eccentric with the outer circumferential surface of the rotor 200, i.e. a center of circle associated with the pole face of the main pole shoe 104b is offset from a center of rotation of the rotor 200. Circumferential lengths of the auxiliary pole shoes 105a and 105b of each second tooth 105 are equal to each other. The pole face of the auxiliary pole shoes 105a is concentric with the outer circumferential surface of the rotor 200. The pole face of the auxiliary pole shoes 105b is eccentric with the outer circumferential surface of the rotor 200, i.e. a center of circle associated with the pole face of the auxiliary pole shoes 105b is offset from a center of rotation of the rotor 200. Therefore, each of the air gaps 107 has an uneven thickness, and is asymmetric with regarded to a central line of the corresponding one of the first teeth 104 and the second teeth 105, such that the motor 500 has different startup capability in opposite startup directions.

Axially-extending grooves 117 are defined in a radial outer side surface of each of the magnetic bridge 116. The number of the axial axially-extending grooves 117 in each of the magnetic bridge 116 is an odd number. In this embodiment, the number of the axially-extending grooves 117 is three. The axially-extending tree grooves are spacedly arranged in a circumferential direction of the magnetic bridge 116. Preferably, a cross-section of each of the grooves 117 is U-shaped. At least one of the axially-extending grooves in each magnetic bridge 116 is communicated with the cutout 106 in the magnetic bridge 116.

In this embodiment, one layer of first stator core lamination 101a and one layer of second stator core lamination 101b are alternatively stacked in the stator core 101. It should be understood that alternatively stacking a plurality of first stator core laminations 101a with a plurality of second stator core laminations 101b is also possible.

### Tenth Embodiment

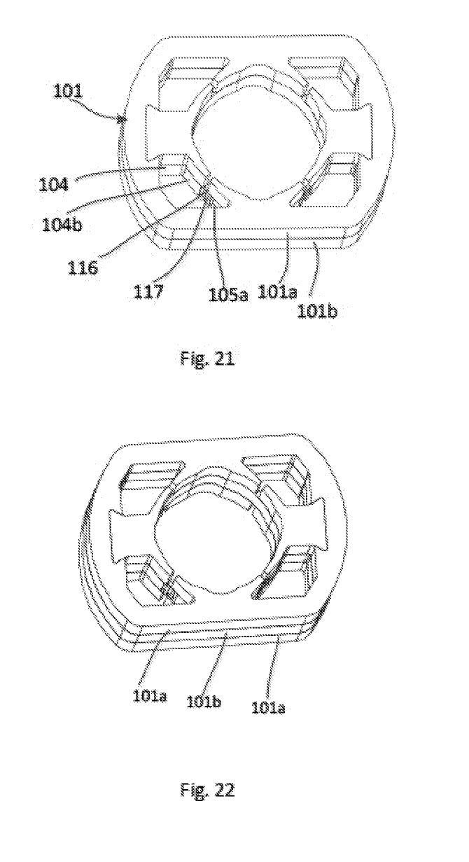

Referring to FIG. 20 and FIG. 21, Referring to FIG. 7, this embodiment differs from the first embodiment mainly in that: each of the air gaps 107 has an even thickness, and is asymmetric with regarded to a central line of the corresponding one of the first teeth 104 and the second teeth 105, such that the motor 500 has different startup capability in opposite startup directions. Circumferential length of the main pole shoe 104a of each first tooth 104 is greater than that of the main pole shoe 104b of the first tooth 104b. The pole faces of the main pole shoes 104a and 104b of each first tooth 104 are located on a same circumferential surface concentric with the outer circumferential surface of the rotor 200, i.e. a center of circle associated with the pole faces of the main pole shoes 104a and 104b coincides with the center of rotation of the rotor 200. Circumferential length of the auxiliary pole shoe 105a of each second tooth 105 is greater than that of the auxiliary pole shoe105b of the second tooth 105b. The pole faces of the auxiliary pole shoes 105a and 105b of each second tooth 105 are located on a same circumferential surface concentric with the outer circumferential surface of the rotor 200, i.e. a center of circle associated with the pole faces of the auxiliary pole shoes 105a and 105b coincides with the center of rotation of the rotor 200.

As shown in FIG. 22, one layer of first stator core lamination 101a and one layer of second stator core lamination 101b may be alternatively stacked in the stator core 101. It should be understood that it is also possible to alternatively stack a plurality of first stator core laminations 101a with a plurality of second stator core laminations 101b.

Referring to FIGS. 5, 6, 8, and 9, the rotor 200 may be any of the structures as described above.

### Eleventh Embodiment

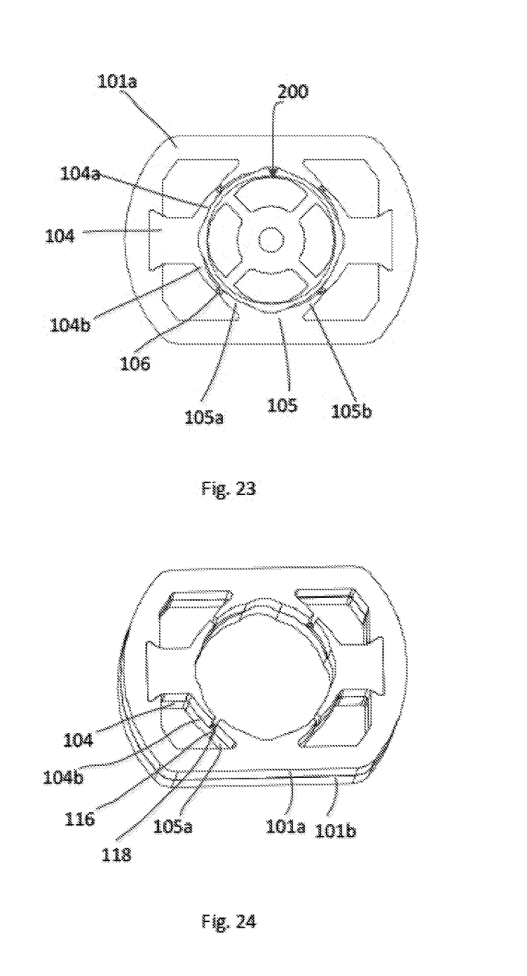

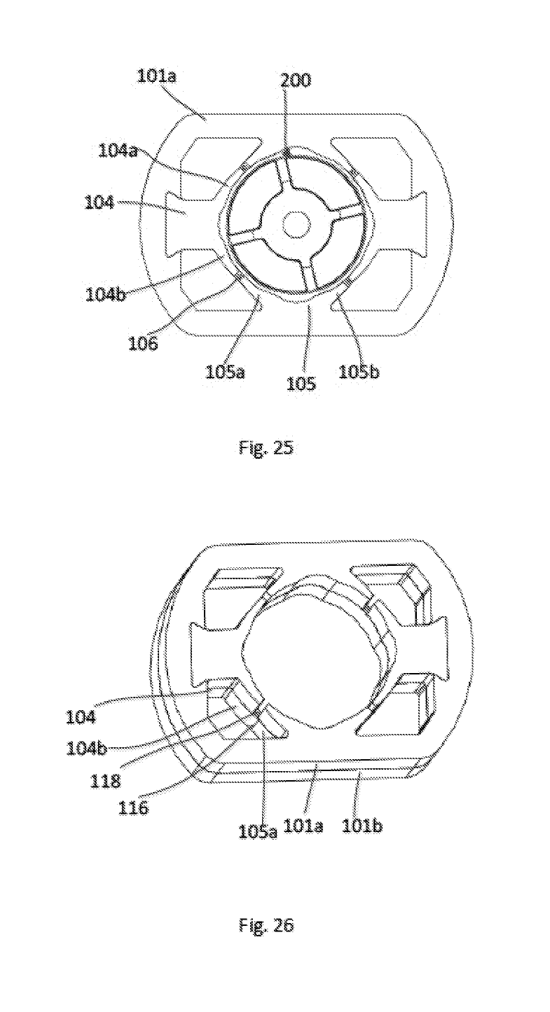

Referring to FIG. 23 and FIG. 24, this embodiment differs from the first embodiment mainly in that: axially-extending through holes 118, instead of axially-extending grooves 117, are defined in the magnetic bridge 116. The provision of the through hole 118 likewise can increase the magnetic reluctance. The number of the through holes 118 in each of the magnetic bridge 116 is an odd number. In this embodiment, the number of the through holes 118 is three. The through holes 118 are spacedly arranged along a circumferential direction of the magnetic bridge 116, with a middle one of the through holes 118 greater than side ones in diameter. Such that the middle area of the magnetic bridge 116 has the maximal magnetic reluctance.

### Twelfth Embodiment

Referring to FIG. 25 and FIG. 26, this embodiment differs from the first embodiment mainly in that: axially-extending through holes 118, instead of axially-extending grooves 117, are defined in the magnetic bridge 116. The provision of the through hole 118 likewise can increase the magnetic reluctance. The number of the through holes 118 in each of the magnetic bridge 116 is an odd number. In this embodiment, the number of the through holes 118 is three. The through holes 118 are spacedly arranged along a circumferential direction of the magnetic bridge 116, with a middle one of the through holes 118 greater than side ones in diameter. Such that the middle area of the magnetic bridge 116 has the maximal magnetic reluctance.

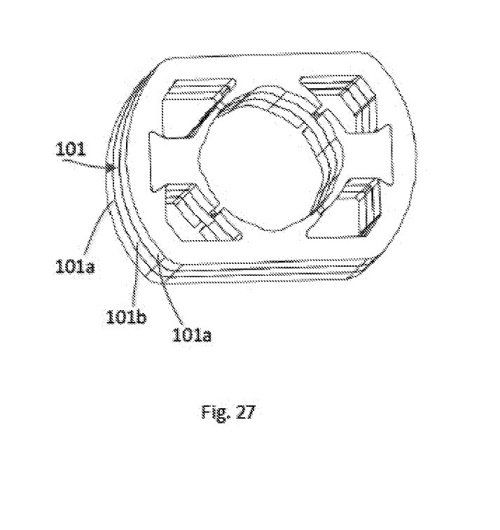

As shown in FIG. 27, one layer of first stator core lamination 101a and one layer of second stator core lamination 101b may be alternatively stacked in the stator core 101. It should be understood that it is also possible to alternatively stack a plurality of first stator core laminations 101a with a plurality of second stator core laminations 101b.

Although the invention is described with reference to one or more preferred embodiments, it should be appreciated by those skilled in the art that various modifications are possible. Therefore, the scope of the invention is to be determined by reference to the claims that follow.

1. A brushless motor comprising:
a stator comprising a stator core and a plurality of windings, the stator core comprising:
a yoke;
a plurality of teeth extending from the yoke, each of the teeth comprising two pole shoes extending in opposite ways along a circumferential direction of the yoke, pole shoes of adjacent teeth are connected through a magnetic bridge having a larger magnetic reluctance than that of the poles shoes, axial thickness of each of the magnetic bridges being smaller than that of the poles shoes; and
a rotor rotatably received in a space bounded by the teeth of the stator core.

2. The brushless motor of claim 1, wherein the plurality of teeth comprises:
a plurality of first teeth receptively wound with one of the wind; and
a plurality of second teethas same as the first teeth in number, the second teeth avoiding being wound with any winding, the first teeth and the second teeth are alternatively arranged along a circumferential direction of the yoke, each of the first teeth.

3. The brushless motor of claim 1, wherein the stator core defines at least one cutout adjacent to each magnetic bridge, at least one opposite axial ends of each cutout is closed by the corresponding one magnetic bridge.

4. The brushless motor of claim 3, wherein the stator core comprises axially stacked first stator core laminations and second stator core laminations, pole shoes of each adjacent teeth in the first stator core are respectively connected through the magnetic bridges, the cutouts are defined between pole shoes of adjacent teeth in the second stator core.

5. The brushless motor of claim 3, wherein said at least one cutout comprises two cutouts arranged at opposite ends of one of the magnetic bridges.

6. The brushless motor of claim 1, wherein at least one axially-extending groove is defined in a radial outer side surface of each of the magnetic bridge.

7. The brushless motor of claim 6, wherein one of said at least one of the axially-extending grooves in each magnetic bridge is communicated with the cutouts adjacent to the magnetic bridge.

8. The brushless motor of claim 6, wherein a cross-section of each of the axially-extending grooves in the magnetic bridge is U-shaped.

9. The brushless motor of claim 6, wherein the number of the axially-extending grooves in each of the magnetic bridge is an odd number.

10. The brushless motor of claim 1, wherein at least one axially-extending through hole is defined in each of the magnetic bridge.

11. The brushless motor of claim 10, wherein one of said at least one of the axially-extending through hole in each magnetic bridge is communicated with the cutouts adjacent to the magnetic bridge.

12. The brushless motor of claim 10, wherein the number of the axially-extending through hole in each of the magnetic bridge is an odd number.

13. The brushless motor of claim 4, wherein air gaps are formed between an outer circumferential surface of the rotor and respective pole faces of the teeth, the pole faces of the stator core formed with different stator core laminations are staggered in a radial direction.

14. The brushless motor of claim 1, wherein the rotor comprises a rotary shaft, a rotor core fixed to the rotary shaft, a plurality of permanent magnets attached to an outer circumferential surface of the rotor core, and a holding member, the permanent magnet fixing member is sleeved on the rotor core and tightly hoops the plurality of permanent magnets.

15. The brushless motor of claim 14, wherein the holding member comprises a barrel-shaped main portion and two connecting portions respectively connected to opposite axial ends of the main portion and integrally formed with the main portion, the main portion tightly hoops the permanent magnets, and the two connecting portions are connected to the rotary shaft.

16. The brushless motor of claim 1, wherein the rotor comprises a rotary shaft, a rotor core fixed to the rotary shaft, and a plurality of permanent magnets embedded in the rotor core.
